(19) United States
(12) Patent Application Publication
(10) Pub. No.: US 2021/0075752 A1
(43) Pub. Date: Mar. 11, 2021

(54) FEEDBACK-DRIVEN ENTERPRISE COMMUNICATIONS PLATFORM

(71) Applicant: Employee Channel, Inc., San Francisco, CA (US)

(72) Inventors: Mark Oney, Danville, CA (US); Jorge Jimenez, San Francisco, CA (US); Sandy Yu, Millbrae, CA (US)

(21) Appl. No.: 16/566,116

(22) Filed: Sep. 10, 2019

(51) Int. Cl. H04L 12/58; G06N 20/00; G06Q 10/10

(52) U.S. Cl. CPC H04L 51/046; G06N 20/00; G06Q 10/107; H04L 51/22; H04L 51/16

(57) ABSTRACT

The present invention comprises a feedback-driven enterprise communications platform that continuously monitors and improves the effectiveness of communications within and across organizations. In one embodiment, it employs supervised machine learning techniques to correlate the attributes of such communications (e.g., topic, purpose, sentiment, authors, target audience, title and body length, publication date and time, inclusion of images, video and other media, as well as various other characteristics) with metrics representing the behavioral interactions with such communications by dynamically changing target audiences. The present invention utilizes such correlations to optimize predefined communications-related goals (defined as functions of such metrics) by generating advice (e.g., in the form of ranges of attribute values) designed to improve over time the two-way dialogue between the authors of communications and their dynamically changing target audiences. Such advice is segmented across one or more dimensions (e.g., different authors, departments or other audience segments, communication types, time periods, etc.).

### BACKGROUND

### Field of Art

The present invention relates generally to the field of enterprise communication systems, and in particular to a feedback-driven communications platform that continuously monitors and improves the effectiveness of communications within and across organizations.

### Description of Related Art

Enterprise communications are transmitted over various different media. While spoken and written communications are still delivered in-person, by phone and in paper form, information is conveyed far more commonly today via networked software applications running on a multitude of computer-based systems. Such systems provide new and improved forms of communication over time, ranging from more traditional email, messaging and conferencing applications to an ever expanding variety of vertical networked applications that integrate voice, text, graphics, and video with a host of collaborative and interactive features.

Such communications include internal communications (e.g., between management and employees, or among all personnel or distinct departments of an organization) as well as external communications (e.g., between a company and its customers, suppliers or other external entities). While this application focuses on internal communications between management and employees of an enterprise, the concepts set forth herein are applicable to virtually all forms of communications within and across organizations and the various individuals and groups with which they interact.

While much of the content of an organization's communications is not typically accessible in a centralized repository (even if maintained in storage on one or more computer systems), most enterprises maintain numerous centrally accessible “knowledge bases” consisting of a vast array of individual communications or “content items”—including documents ranging in size from short alerts, surveys and educational vignettes to longer white papers and articles. These content items are often maintained in internal wikis and in a variety of database records stored both on-site and in external third-party databases accessible via standard and custom APIs.

Apart from the inherent problem of integrating content (maintained in disparate forms across an array of computer systems) to make it accessible to relevant personnel, other significant communications-related problems plague both small and large enterprises. In particular, for management within an enterprise to communicate effectively with its employees, it must: (1) maintain the relevance, utility, accuracy and comprehensiveness of knowledge base content over time—by generating, organizing and publishing new and revised content in a timely fashion for distribution to appropriate groups of employees (the nature and membership of which also changes over time); and (2) make knowledge base content readily accessible to employees with minimal “friction” so as to avoid unnecessarily overburdening administrative support staff.

Yet existing systems are lacking with respect to both content generation and content searching capabilities. Management communications are often not published in a timely fashion, and are of limited interest to most employees. They are typically not kept current or maintained based on employee feedback. In short, authors typically do not “have their finger on the pulse” of the organization's employees when preparing content. They aren't acutely aware of what employees are searching for and what they currently care about. Because employee feedback is not adequately taken into account, desired content becomes difficult (if not impossible) to find, resulting in failed searches across a knowledge base full of “gaps” in relevant material.

While some existing systems are designed to improve the “quality” of content, they do not address the issue of improving a two-way communication process by correlating that content over time with the dynamic interests and needs of relevant audience segments. For example, the “Hemingway App” (at www.hemingwayapp.com) analyzes the style of a content item and makes suggestions to modify it to make it clearer and easier to understand. A similar system (“Textio Hire” at www.textio.com, and further described in U.S. Pat. App. No. 2016/0350672) is focused on improving the process of successfully hiring job applicants by predicting the individual features of job advertisements for the purpose of improving the yield of successful hires.

Current systems fail to address the obstacles inherent in the “two-way dialogue” between authors of various types of communications and the dynamic targeted audiences that interact with such communications (e.g., by reading or not reading them, providing comments or other forms of feedback, etc.). By not taking such interactive feedback into account, existing systems fail to provide authors with advice reflecting whether targeted segments of employees are likely to be interested in particular content, much less whether they will consume and engage with such content.

It is one thing to predict whether specific attributes of a content item are likely to achieve a desired result (such as the hiring of a qualified job applicant), and quite another to correlate particular attributes with a desired communications-related goal reflecting the two-way dialogue that occurs over time between authors of various types of communications and the dynamic targeted audiences that interact with such communications. The more complex problem of improving communication effectiveness over time suggests a need for advice across multiple “dimensions”—such as different categories of authors, types of communications, and departments of an organization or other audience segments over particular periods of time.

It is important to note that the behavioral interactions of targeted audiences (whose nature and membership change over time) with published content are more than merely the result of access to such content. They are also an integral component of a two-way communication process. While traditional computer-based analytics could enable the discovery (and, in some cases, the prediction) of meaningful patterns in the metrics, such analytics still require authors to manually internalize and determine how to respond to those patterns in the course of producing future content.

What is needed is a system that analyzes the behavioral interactions that occur as audiences access published content items, and transform this “feedback” into descriptive, predictive and prescriptive “advice” to enable content authors to continuously supplement and improve the utility, relevance, accuracy, comprehensiveness and accessibility of knowledge base content in a manner that engages dynamically changing target audiences, and thereby improves communication effectiveness on a continuous basis over time. In short, it is desirable to improve this two-way communication process itself by correlating content with the behavioral interactions of dynamically changing target audiences.

### SUMMARY

The present invention provides a computer-based enterprise communications platform that:
Continuously monitors interactive behavior of target audiences who access, consume, interact with and search for published content items;
Extracts, quantifies and processes behavioral metrics representing such interactive behavior and defines one or more goals as a function of such behavioral metrics;
determines communication effectiveness over time across one or more dimensions, based at least in part upon such behavioral metrics; and
analyzes current and historical behavioral metrics to transform this feedback into descriptive, predictive and prescriptive advice to content authors;
thereby improving overall communication effectiveness on a continuous basis over time.

The present invention essentially serves as a “coach” that monitors the two-way communication process between authors and publishers of communications (e.g., management within an organization) and the intended recipients of such communications (e.g., employees) who access, interact with and respond to such communications. While human coaches use their own professional judgment and experience to analyze communications and determine how best to advise authors to generate communications for the purpose of improving the effectiveness of this two-way communication process, the present invention employs a variety of novel techniques to transmute the coaching role into one that involves not only generating advice automatically, but also continuously correlating such advice to dynamically changing target audiences.

In an effort to quantify the successful performance of particular activities, organizations establish goals—often referred to as “key performance indicators” (KPIs)—that are tailored to such activities across all or various subsets of the organization. For example, in the context of quantifying effective communication between management and its employees, such KPIs may include employee “engagement” (e.g., the extent to which employees are enthusiastic about their work and actively promote the interests of the organization), “readership” (e.g., the extent to which employees read and internalize particular content), “relevance” (e.g., the extent to which the organization maintains content that is relevant to the needs of its employees), “search efficacy” (e.g., the extent to which employees can efficiently obtain answers to their questions by searching the organization's knowledge base), and various other indicators of effective communication. Different organizations may place different weights on these various KPIs, and may also define an overall company-specific measure of communication effectiveness—i.e., a function of various KPI parameters.

Because the present invention is focused on improving the two-way dialogue between authors and their dynamically changing target audiences, it represents an organization's goals as a function of the metrics derived over time from the interaction of various audiences with authors' published communications. Raw metrics include (among many others) indications as to whether an audience member opened, read, “liked” or dismissed a particular communication, clicked on a particular link, responded to a requested action or provided a comment or other feedback, as well as the date and time of such interactions.

In one embodiment, the present invention processes such raw metrics to generate derived metrics, such as the open rate of a particular communication (e.g., the number of unique audience members who opened the communication relative to the size of the targeted audience) or the like rate (e.g., the number of unique likes relative to the number of opens). It then aggregates such derived metrics across one or more dimensions, such as different categories of authors, types of communications, and departments of an organization or other audience segments over particular periods of time.

The present invention represents an organization's goals as predefined functions of these raw, derived and aggregated metrics. In one embodiment, it defines a single goal, as a function of one or more component goals or KPIs, to represent the overall effectiveness of communication at any given point in time, or over various periods of time or other dimensions.

Individual communications have certain attributes, such as a communication type, a topic, a purpose, a sentiment, one or more authors, a target audience, a title and body length, a publication date and time, the presence of certain media (text, images, videos, etc.) and many other characteristics. In one embodiment, each of these attributes is quantified and represented as a range of attribute values.

To improve an organization's predefined goals or KPIs over time, the present invention, in one embodiment, automatically generates advice relating to particular attribute values (or sub-ranges of attribute values) for one or more attributes of future communications. Because the nature and membership of various target audiences changes dynamically over time (reflected in changing metrics), the present invention generates such advice on a continuous basis in an effort to correlate that advice with dynamically changing target audiences in a manner that optimizes the organization's predefined KPIs or other goals. By incorporating this feedback-related advice into future communications (with which targeted audience members interact), authors complete this two-way communication cycle in a manner designed to improve over time the two-way dialogue between authors and dynamically changing target audiences.

It should be emphasized that there is no “ideal” communication or set of attribute values that will achieve an organization's goals—because the present invention does not correlate a single communication or type of communication with a desired result, but instead correlates attributes of communications generally with changing metrics over time that reflect the dynamic nature of target audiences. In short, the present invention does not merely predict metrics or KPIs from given ranges of attribute values. It incrementally improves an organization's predefined goals over multiple iterations of correlating its advice to the behavioral interactions of dynamically changing target audiences across one or more dimensions. In one embodiment, such advice is itself segmented by different authors, audiences and communication types, as well as various periods of time.

The present invention employs supervised machine learning techniques (in one embodiment) to generate trained models that correlate ranges of attribute values with predicted metrics. It utilizes those correlations to generate a landscape of ranges of attribute values from which it produces advice (in the form of particular ranges of attribute values) that is predicted to optimize an organization's predefined goals (functions of those metrics) over time. It then employs threshold formulas to determine when to present that advice to authors, thereby completing the “feedback” component of the two-way communication cycle. Finally, authors utilize that advice to generate subsequent communications in further iterations of this cycle (resulting in subsequent interactions by targeted audiences which determines further “movement” of the organization's predefined goals from which subsequent iterations of advice are generated).

The present invention facilitates an organization's overall ability to define a communications strategy, develop a communications plan and implement that plan through various different types of communications, assisted by automated “advisory services” across dynamically changing target audiences. In one embodiment, the present invention implements a hierarchical structure of content—from individual programs, each containing a plurality of campaigns, each of which in turn comprises a plurality of activities, each of which ultimately includes individual communications of various types (including short alerts, surveys, polls and moderated forums, as well as educational vignettes and longer white papers and articles).

In another embodiment, multi-level goals are employed—e.g., an overall communication effectiveness KPI, which is a function of lower-levels goals/KPIs, such as engagement, readership, relevance and search efficacy. Any number of hierarchical levels may be employed without departing from the spirit of the invention.

At a high level, the present invention automatically generates advice (such as suggested topics or key concepts, as well as other lower-level attributes of communications) that enable authors to “have their finger on the pulse” of the organization's employees when preparing future communications. In one embodiment, such advice takes on various forms, including descriptive advice (that essentially informs authors what has happened as metrics changed over time), predictive advice (that provides authors with predictions regarding what will happen in the future) and, perhaps most importantly, prescriptive advice (i.e., actionable recommendations in the form of suggested ranges of values of communication attributes designed to optimize the organization's predefined goals).

The resulting communications, based at least in part on the extraction of factors that most resonate with their target audiences, effectively represent an awareness of what employees are searching for and what they currently care about (which, of course, changes over time). They are more useful, relevant, accurate, comprehensive, accessible and engaging. The overall result is an improvement in the effectiveness of the two-way dialogue between the authors of such communications and their dynamically changing target audiences.

### BRIEF DESCRIPTION OF DRAWINGS

FIG. 1 is a block diagram illustrating one embodiment of an architectural system overview and key features of the present invention;

FIG. 2 is a flowchart illustrating one embodiment of key steps of a process of the present invention that automatically generates advice to authors of communications for the purpose of improving the effectiveness over time of a two-way dialogue between the authors and targeted audiences of such communications;

FIG. 3A is a graph illustrating one embodiment of a timeline measuring one aspect of communication effectiveness (“engagement”) over various periods of time;

FIG. 3B is a “baseline” section of the graph of FIG. 3A illustrating an initial period of time during which the present invention monitors and analyzes metrics and generates advice, but has not yet delivered such advice to authors of communications;

FIG. 3C is a “medium-term increase” section of the graph of FIG. 3A illustrating a period of time during which the level of engagement increases as a consequence of the automatically-generated advice generated by the present invention and delivered to authors of communications;

FIG. 3D is a “medium-term decrease” section of the graph of FIG. 3A illustrating a period of time during which the level of engagement decreases despite the influence of automatically-generated advice (e.g., as a result of changes in the nature and membership of targeted audiences);

FIG. 3E is a “medium-term adaptive increase” section of the graph of FIG. 3A illustrating a period of time during which the level of engagement increases as a consequence of the present invention adapting to changes in targeted audiences over time and automatically generating advice reflecting such changes;

FIG. 3F is a “long-term adaptive increase” section of the graph of FIG. 3A illustrating a relatively long period of time during which the level of engagement increases significantly (despite short-term and medium-term increases and decreases reflecting changes in targeted audiences over shorter periods of time) as a consequence of the present invention continuously adapting to such changes over time;

### DETAILED DESCRIPTION

System diagram 100 illustrates an embodiment of key architectural components of the present invention. In this embodiment, a Communications Server 101 is employed to facilitate a two-way communication process, via the Internet 175, among authors 194 and viewers 195 of one or more enterprises 190. It should be noted that authors may also be viewers of particular communications (and vice-versa).

While the functionality of Communications Server 101 may be implemented in a single physical server in one embodiment, it may in other embodiments be distributed across multiple physical computing devices, each having different subsets of the components illustrated in Communications Server 101. In other embodiments, such components are combined into higher-level components, divided into additional discrete subcomponents and/or implemented in different combinations of software and hardware.

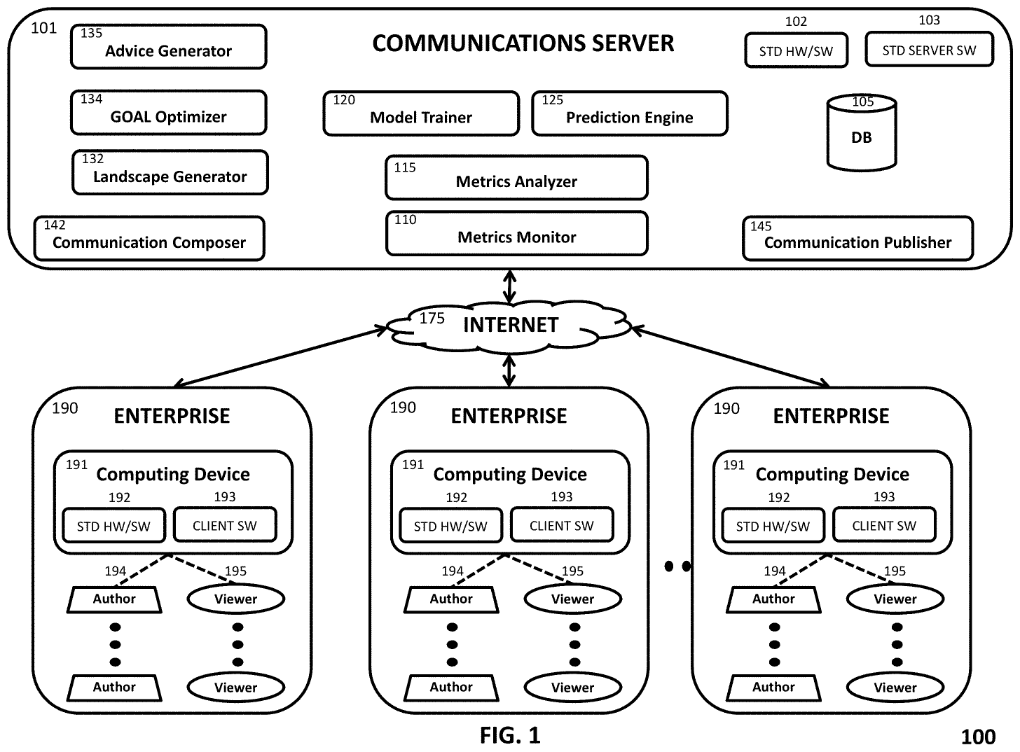

In the embodiment illustrated in FIG. 1, Communications Server 101 is shown as a single physical server with standard hardware and software components 102 (including, for example, one or more single-processor or multi-processor CPUs, RAM and other transient memory as well as non-transitory computer-accessible storage media, various input and output devices such as keyboards, mice, trackpads, microphones and speakers and screen displays and standard operating systems software). In addition to such standard hardware and software components 102, Communications Server 101 also includes standard server software 103, such as a web server, communications server and other server-based packages. In this embodiment, the various software modules of Communications Server 101 are stored in non-transitory computer-accessible storage media for execution by CPUs and/or other processors.

Data processed by the various modules of Communications Server 101 are maintained and stored in database 105. In some embodiments, database 105 is implemented as a single database, while in other embodiments it is implemented as multiple distinctly independent databases or as a hybrid collection of independent and interrelated databases. For example, in some embodiments, distinct databases are employed for storing (i) individual communications and their communication attribute values; (ii) raw metrics collected from behavioral interactions with individual communications; (iii) profiles and other metadata relating to viewers 195 and authors 194, (iv) machine-learning models for predicting communication attribute values; and (v) advice generated for authors 194 across various dimensions.

While authors 194 and viewers 195 are illustrated within their enterprise 190, each typically uses its own computing device 191 (e.g., smartphone or a laptop or desktop computer) to generate, receive and interact with communications. Computing devices 191 include standard hardware and software components 192 (akin to those described above with respect to Communications Server 101), and client software 193, which implements the functionality of communicating with Communication Server 101 and interacting with communications. In one embodiment, client software 193 is implemented with standard web browser software, though in other embodiments, custom software is employed, such as custom Javascript code or a custom smartphone app. The particular implementation of client software 193 is a result of design and engineering tradeoffs relating to the particular desired user interface and interactive features. In some embodiments, viewers 195 are provided with a choice of smartphone apps and web-based applications for interactions with Communication Server 101.

Authors 194 of communications utilize (via the Internet 175) the Communication Composer authoring tool 142 of Communication Server 101 to facilitate their generation of individual communications. Communication Composer tool 142 integrates the advice generated by communications server 101 in a manner that enables authors 194 to incorporate such advice into their communications. For example, in one embodiment, the user interface reflects whether particular communication attribute values fall within suggested ranges, such as the length of the communication's title, the sentiment of a sentence or paragraph in the body of the communication or the departments comprising the intended target audience.

In another embodiment, Communication Composer 142 employs multiple advisors to manage distinct types of advice, each with its unique user interface to implement the presentation of the advice, as well as real-time feedback and other relevant features. For example, employing a hierarchical model, an enterprise may utilize a high-level “communication strategy planner” to determine how best to structure its communications—e.g., via one or more individual “programs,” each having one or more “campaigns,” which in turn consist of various different types of communications, such as short alerts, surveys, polls and moderated forums, as well as educational vignettes and longer white papers and articles.

In some embodiments, separate “publication advisors,” “program advisors,” “campaign advisors,” “survey advisors,” “forum advisors,” “vignette advisors,” “article advisors” and/or “knowledge base content advisors” are employed to manage advice at various different levels of abstraction. For example, a program advisor may provide advice regarding the most effective types of campaigns to be employed at particular times, while a campaign advisor might recommend, for a given campaign, when to employ a survey as opposed to an educational vignette or white paper. Lower-level advisors (e.g., an article advisor) might recommend a particular range of communication attribute values for a specific communication.

As authors 194 compose individual communications, Communication Composer 142 generates the values (and value ranges) of various communication attributes with respect to that communication. In one embodiment, for a given communication, its communication attributes include the following:
Author(s)
Type (e.g., article, educational vignette, survey, event, action required, etc.)
Topic (e.g., news, marketing, technical, health, etc.)
Purpose (e.g., educational, motivational, etc.)
Title/Body Sentiment (e.g., positive, neutral, negative, informative, comparative, compelling, etc.)
Reading Level (e.g., high school level, college level, etc.)
Keywords
Reference to higher-level Program or Campaign (of which Communication is a “member”)
Publication Timestamp
Target Audience
Title Length
Title Style/Title Effectiveness
Body Length
Body Style
Media (e.g., chart, table, image, animation, audio, video, etc.—beyond mere text)

Communication Composer 142 employs natural language processing (NLP) techniques to generate values for certain attributes, such as identifying the topic or determining the sentiment of a communication (or its title) or its reading level. NLP techniques are customized for the particular needs of an enterprise—e.g., employing particular values and value ranges consistent with the predefined goals or KPIs of the enterprise. In one embodiment, NLP is also employed with respect to comments and other feedback provided by viewers 195 to provide authors 194 with additional insight.

Once authors 194 generate a completed communication, they utilize Communication Publisher tool 145 to publish the communication to the specified target audience, including the nature of that audience (e.g., one or more individuals and/or departments within an enterprise) and the timing of the publication (e.g., publish on a particular date and time, or at specified intervals or upon the occurrence of one or more specified conditions). Communication Publisher tool 145 facilitates the publication of communications to their target audiences in accordance with the specified timing, employing standard server software 103 to send the communication via the Internet 175 to the relevant viewers 195 within the enterprise 190.

In one embodiment, upon publication of a communication, viewers 195 within the target audience of that published communication are notified of the publication event via email, text message and/or other mobile notification (e.g., with a click-thru to the mobile app) on their client computing device 191. Viewers 195 thereafter may invoke their client software 193 to interact with that communication—e.g., by opening it, reading it and perhaps generating a response. Communication Publisher 145 stores the “timestamp” (date and time) of each publication event in database 105.

Metrics Monitor 110 works in collaboration with client software 193 to monitor the raw interactions of viewers 195 with individual communications. In one embodiment, Metrics Monitor 110 collects and maintains a variety of raw metrics, including timestamps of each interaction of each viewer 195 with each communication. This enables, for example, tracking the length of time that transpired between the publication of a communication and an individual viewer's “opening” of that communication (as well as “repeat” openings of that same communication over time). Other interactions include “viewing” a summary link to a communication (e.g., my moving a cursor over that summary), “reading” a communication (e.g., inferred based upon the time between opening and dismissing the communication, or scrolling to the bottom of the communication) and “dismissing” a communication (e.g., by explicitly selecting a close or dismiss button).

Additional interactions include clicking on a button to indicate positive or negative feelings about a communication (e.g., a “like” or “dislike” button), clicking on an author's link in a communication to view related content or providing more detailed feedback in the form of a written comment. In other embodiments, some interactions are specific to particular types of communications, such as an “add to calendar” action in response to an “event” communication or selection of a subset of action choices or a “mark as complete” option for communications that require selection of a response. Metrics Monitor 110 may collect various other raw metrics or subsets of those disclosed herein without departing from the spirit of the present invention.

As Metrics Monitor 110 collects raw metrics across multiple viewers 195 and communications, Metrics Analyzer 115 derives composite metrics from those raw metrics, reflecting, for example average or other derived rates across viewers 195 accessing a particular communication. For example, an “open rate” measures over time the number of unique opens of a communication relative to the total number of viewers 195 to which the communication was delivered. Metrics Analyzer 115 derives similar “like rates” and “comment rates” with respect to the number of unique opens.

Metrics Analyzer 115, in addition to calculating these various “derived metrics,” further generates “aggregated metrics” across one or more different “dimensions.” For example, with respect to the dimension of time (e.g., hour of the day or day of the week, range of hours, weekdays, weekends, etc.), it calculates the number of times a communication was opened (or liked, commented on, etc.) as well as the open rate or other rate associated with that time dimension.

Moreover, Metrics Analyzer 115 calculates aggregated metrics across multiple communications (in some cases limited to particular types of communications), whether or not limited to particular time dimensions. Such aggregated metrics are further segmented (alone or in combination with other dimensions) by particular authors 194 as well as audience departments or other groups.

In addition to aggregating across multiple communications or communication types, Metrics Analyzer 115 also calculates aggregated metrics segmented across ranges of values of one or more communication attributes. For example, Metrics Analyzer 115 calculates an open rate with respect to communications having “short” titles (e.g., 1-3 words), “medium” body lengths (e.g., 300-500 words), a “neutral” purpose and/or a “college-level or above” reading level, among various other communication attributes (individually or in combination).

Finally, Metrics Analyzer 115 employs these derived metrics and aggregated metrics to quantify the various KPIs or goals of an enterprise, represented as predefined functions of these metrics. For example, an enterprise might define a simple engagement KPI as the average (across all communications) of the sum of their open rate, like rate and comment rate. In this manner, Metrics Analyzer 115 continuously calculates a “real-time” value of the enterprise's engagement level (whether across all dimensions or segmented by a subset of one or more dimensions). An enterprise may define any of its goals (individually or in combination) as a function of these raw, derived and/or aggregated metrics.

These calculations of real-time values of engagement and other goals are employed, as discussed in greater detail below, to facilitate the generation of advice provided to authors 194 in a manner that is correlated with the “predicted” behavioral interactions of dynamically changing target audiences. For example, if a particular audience segment tends to respond positively (as measured by the engagement KPI for that audience segment) to communications having short titles, a medium body length written at a high school level and a video, then the advice generated for authors 194 targeting that audience segment may reflect those communication attribute values/ranges—at least until such time as the nature or composition of the targeted audience changes, which in turn will be reflected in the generation of different advice (whether solely via different communication attribute values or also via a different set of communication attributes).

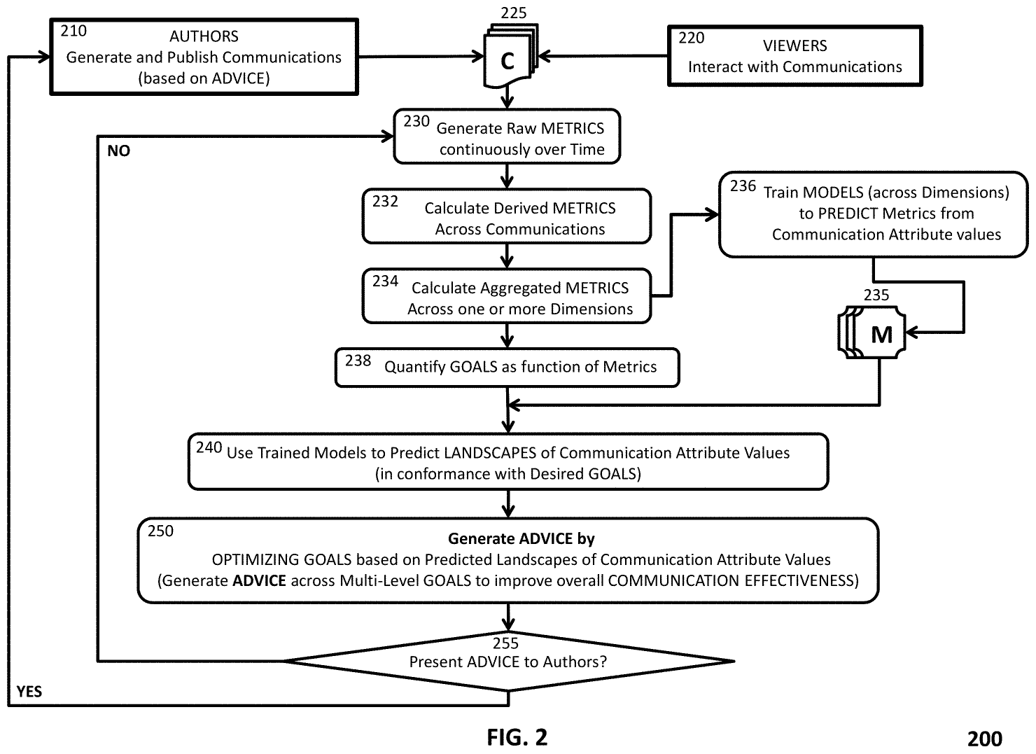

The remaining components of Communication Server 101 relate to its generation of advice for authors 194, with the overall process managed in this embodiment by Advice Generator 135 and described in greater detail below with reference to FIG. 2. As Metrics Monitor 110 and Metrics Analyzer 115 continuously generate raw, derived and aggregated metrics, Model Trainer 120 utilizes these metrics to produce training samples to train one or more predictive models.

In one embodiment, raw metrics are employed as sample observed or “reference outputs” with respect to each communication, with corresponding training sample inputs represented by the attribute values (or value ranges) of that communication. Employing standard supervised machine-learning techniques, such a model (once trained) is utilized by Prediction Engine 125 to predict particular raw metric values from a given set of communication attribute values or value ranges. In other embodiments, combinations of raw, derived and aggregated metrics are employed as reference outputs.

Moreover, in some embodiments, trained models are segmented by one or more dimensions. For example, its predictions may be constrained to a particular time dimension (e.g., continuous time windows, such as the prior six months, as well as discrete time periods such as weekends, summer, etc.), audience segment (e.g., engineering department), communication type (e.g., surveys), topic (e.g., vacation policy), author or group of authors and/or virtually any other relevant segment or combination thereof within a particular enterprise. By constraining a model's predictive capabilities to one or more of these dimensions, such predictions facilitate the generation of more targeted advice to authors 194.

In one embodiment, Model Trainer 120 continuously trains one or more models over time, employing supervised machine learning techniques that iteratively adjust weights in accordance with a “loss function” that quantifies a model's current level of inaccuracy or “error level”—i.e., the deviation of its predicted outputs from actual reference outputs. Additional techniques are employed to ensure a sufficiently robust or “representative” set of training samples.

Once the error level generated by a model's loss function falls below a predefined threshold (across a sufficiently representative set of training samples), the model is deemed to be trained. Prediction Engine 125 utilizes this “current” trained model while Model Trainer 120 continues to train this model with training samples (new and old) generated over time in an effort to continuously improve its accuracy. In another embodiment, models 235 are retrained periodically (e.g., every 6-12 months) with more recent “fresh” data.

In one embodiment, Landscape Generator 132 utilizes Prediction Engine 125 to generate predicted metrics (including goals/KPIs calculated from such metrics) for entire domains of communication attribute values (or value ranges) across one or more dimensions. For example, with respect to a particular communication attribute, such as title length, Landscape Generator 132 may utilize Prediction Engine 125 to generate “engagement” KPI values for predefined ranges of small, medium and large title lengths.

In that example, Goal Optimizer 134 might then select the “small” title length as the one that produced the highest (optimal) engagement level. In other embodiments, Landscape Generator 132 utilizes Prediction Engine 125 to generate engagement KPI values for various combinations of multiple communication attributes (e.g., publication date and publication time, title length and body length and target audience, communication type and reading level, etc.), as well as for segmented dimensions (e.g., limiting predictions to a particular department or period of time).

For example, Goal Optimizer 134 might determine that publishing a particular type of communication (e.g., a survey) yields the optimal engagement level if published on Fridays between 3 PM and 5 PM. Yet, a different day and time might be optimal for the engineering department, as opposed to the marketing department. As will become apparent, optimal predictions for any given goal/KPI may vary for different combinations of communication attributes segmented across one or more dimensions.

In one embodiment, Advice Generator 135 manages this entire process of directing Landscape Generator 132 to utilize Prediction Engine 125 to generate various different landscapes. For example, an enterprise 190 may desire that its authors 194 receive only advice that is optimized for a single goal reflecting overall communication effectiveness (represented, for example, by a predefined function of engagement, readership and various other KPIs). Moreover, the enterprise 190 may desire to limit such advice to specified individual communication attributes or combinations thereof. Advice Generator 135 instructs Landscape Generator 132 to utilize Prediction Engine 125 to generate predicted landscapes in accordance with such predetermined configurations, and instructs Goal Optimizer 134 to optimize such landscapes accordingly.

Advice Generator 135 then formulates the optimal communication attribute values (generated by Goal Optimizer 134 into discrete advice to be presented to authors 194. Advice Generator 135 employs predefined threshold formulas to determine when to present such advice to authors 194. In one embodiment, advice is periodically presented to all authors 194, while in other embodiments, it is presented to authors 194 only when it deviates significantly from prior advice and only when an individual author 194 initiates the authoring process (e.g., by invoking Communication Composer 142).

In one embodiment, advice is presented via a user interface in Communication Composer 142 that enables authors 194 to “filter” the advice by selecting various different dimensions. For example, if an author 194 selects its desired target audience, then the advice may be “recomputed” by generating landscapes only with respect to that target audience, and optimizing such landscapes only with respect to a particular goal or goals (whether preselected by the enterprise 190 or selected in real time by the author 194).

Advice with respect to other communication attributes is displayed to authors 194 in a manner that facilitates the authoring process. For example, title length advice is presented adjacent to the title “field” within the Communication Composer 142 authoring tool, while other advice not specific to a particular field is presented in a general area. In one embodiment, “corrective” advice is generated in real-time, employing NLP techniques to analyze the content as it is generated by authors 194. For example, if an author begins crafting content at a higher reading level than is recommended by the advice (e.g., for a particular target audience), the user interface will reiterate that advice and suggest that the author 194 revise such content. Such suggestions can of course be ignored and disabled if desired, depending upon desired configuration parameters.

Various other methods for determining when and how advice is presented to authors 194 will become apparent to those skilled in the art without deviating from the scope of the present invention.

Turning to FIG. 2, flowchart 200 illustrates one embodiment of key steps of this automated process of generating advice to communication authors 194 over time. Communications 225 are illustrated generically, being generated and published in step 210 by authors taking into account automatically-generated advice, and interacted with by viewers in step 220. Flowchart 200 is focused on the iterative process by which viewers' behavioral interactions with communications over time are continuously “transformed” into advice for authors generating subsequent communications. As noted above, such advice takes into account the dynamically changing nature and membership of target audiences over time.

It should also be emphasized that many of the steps illustrated in flowchart 200 and described below may be performed in parallel, or sequentially to the extent dependencies exist. Such design and engineering choices may be determined by those skilled in the art without departing from the spirit of the present invention.

As viewers interact with individual communications, Metrics Monitor 110 (with the assistance of client software 193) extracts and generates raw metrics in step 230 continuously over time. As noted above, such raw metrics relate to individual viewer interactions with individual communications, including not only the type of interaction (e.g., opening, reading, liking, dismissing, providing feedback, etc.) but also metadata relating to such interaction, such as the elapsed time from the publication of such communication to each particular interaction.

In step 232, Metrics Analyzer 115 calculates derived metrics from such raw metrics—across multiple viewers and communications and various dimensions over time. In one embodiment, as noted above, Metrics Analyzer 115 derives open rates, like rates and comment rates with respect to individual communications, in some cases segmented across one or more dimensions (such as a particular author or target audience).

In step 234, Metrics Analyzer 115 further calculates aggregated metrics across one or more dimensions from such raw and derived metrics. As noted above, with respect to the dimension of time, it aggregates open rates, like rates and comment rates with respect to particular hours of the day, days of the week, weekdays, weekends, etc. Moreover, it aggregates such rates with respect to particular communications or communication types, authors, audience segments, communication attribute value ranges (e.g., short titles, medium body lengths or college reading levels) and various other dimensions. Such aggregations are, in one embodiment, pre-configured by each individual enterprise.

In step 236, Model Trainer 120 utilizes such raw, derived and/or aggregated metrics on a continuous basis to generate training samples which it uses to train one or more models 235. Such models 235 are limited, in one embodiment, to one or more dimensions (such as time, a particular department or a type of communication), but, in other embodiments, are generalized across such dimensions or ranges of attribute values. Once deemed sufficiently trained, such models 235 are employed, as described below, to facilitate predictions of metrics for given communication attribute value ranges.

In step 238, Metrics Analyzer 115 employs these derived and aggregated metrics to quantify the various KPIs or goals of an enterprise, represented as predefined functions of these metrics. As discussed above, any desired goal can be represented as a function of such metrics, including individual KPIs and composite KPIs based on other KPIs, such as an overall measure of communication effectiveness.

In step 240, Landscape Generator 132 utilizes Prediction Engine 125 to generate one or more landscapes (as discussed above), each of which includes a set of predicted metrics for the entire domain of communication attribute value ranges. In one embodiment, such landscapes are one-dimensional in nature—i.e., predicting metrics for all values (or ranges of values) of a single communication attribute. In other embodiments, landscapes are multi-dimensional—i.e., predicting metrics for combinations of values of multiple communication attributes. An enterprise 190 may, for example, predetermine desired combinations of communication attributes for which its goals are to be optimized.

In step 250, such landscapes are employed by Goal Optimizer 134 (at the direction of Advice Generator 135) to determine the communication attribute values (or value ranges) that yield the optimal values for one or more predefined goals. In one embodiment, such goals are hierarchical in nature, such that an optimal value of a higher-level goal (e.g., overall communication effectiveness) may result from sub-optimal values of lower-level goals (e.g., engagement, readership, etc.). For example, if overall communication effectiveness is a function of engagement and readership, the optimal values for engagement and readership may not yield the optimal value for communication effectiveness. In any event, the priority of optimizing for hierarchical or other multi-level goals is based upon predefined configurations.

It should be noted that various optimization algorithms may be employed without departing from the spirit of the present invention. Such algorithms include, for example, newton's method, simplex method, Nelder-Mead method, gradient descent and a plethora of other algorithms and variations thereof. In one embodiment, a stochastic gradient descent algorithm is employed as a more computationally efficient method of iterating through a large domain of values in a landscape. In essence, though only a subset of the landscape's values are selected (e.g., an area around a point), the algorithm still converges to a maximum (optimal) value, albeit in a relatively more random (stochastic) manner.

Advice Generator 135 ultimately determines, in step 250, the actual advice (e.g., particular communication attribute values, or ranges of values, that are predicted to optimize desired goals) which will be presented to authors. Then, in step 255, Advice Generator 135 determines whether and when to present that advice to authors. For example, if the advice is predicted to yield an optimal goal that is lower than the current value of that goal (determined in step 238), then such advice may in fact be detrimental. In one embodiment, such advice is provided only if it is predicted to increase a desired goal by a predefined threshold percentage.

Moreover, in one embodiment, such advice is presented only to authors currently using the Communication Composer 142 authoring tool, while in other embodiments, it is presented to authors via a more general notification. For example, advice indicating that a survey will be highly effective (or perhaps a survey directed to a particular department on a particular topic) may prompt a particular author to invoke Communication Composer 142 to generate such a survey.

Ultimately, once Advice Generator 135 provides its generated advice to authors, processing returns to step 210, at which point authors may or may not take such advice into account in the course of authoring and publishing future communications. And the process of flowchart 200 repeats on a continuous basis.

If Advice Generator 135 determines, in step 255, not to provide the generated advice to authors, then processing returns to step 230, where Metrics Monitor 110 (with the assistance of client software 193) continues to extract and generate raw metrics. As noted above, it will be apparent to those skilled in the art that these steps may be implemented in parallel on a continuous basis, particularly to the extent that no dependencies are present between steps.

It should be emphasized that, regardless of the extent to which authors incorporate such advice into their communications, the present invention continuously analyzes, on a real-time basis, the changes in the predefined goals. In one embodiment, the real-time values of such goals (generated in step 238) are presented to authors and viewers alike—to provide everyone with a continuous measurement of communication effectiveness. In another embodiments, various analytics tools are employed to process such values for “offline” use by enterprise management.

As discussed in greater detail below, such goals may rise or fall over time—even if authors incorporate all of the advice they receive—in part due to the dynamically changing nature and membership of various target audiences. As will become apparent, the process illustrated in flowchart 200 provides a mechanism for authors not only to keep their “finger on the pulse” of the enterprise and the effectiveness of this two-way dialogue with employees, but also to adapt to changes in the nature and membership of their target audiences by receiving advice that reflects such dynamic changes and incorporating that advice into future communications in an effort to improve communication effectiveness over time.

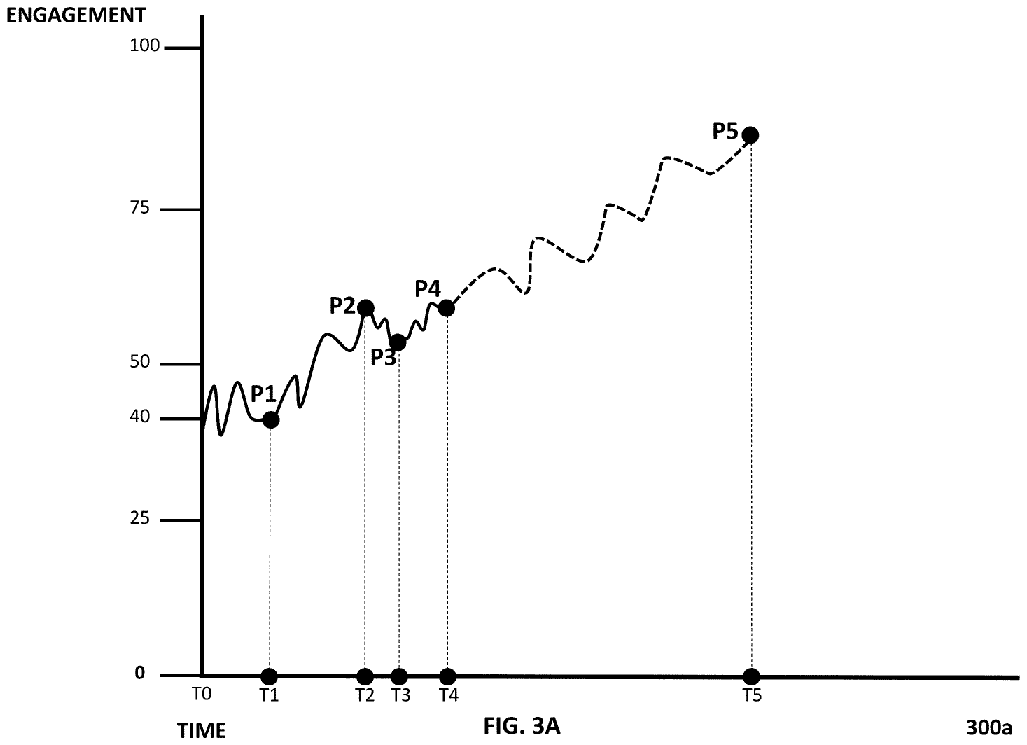

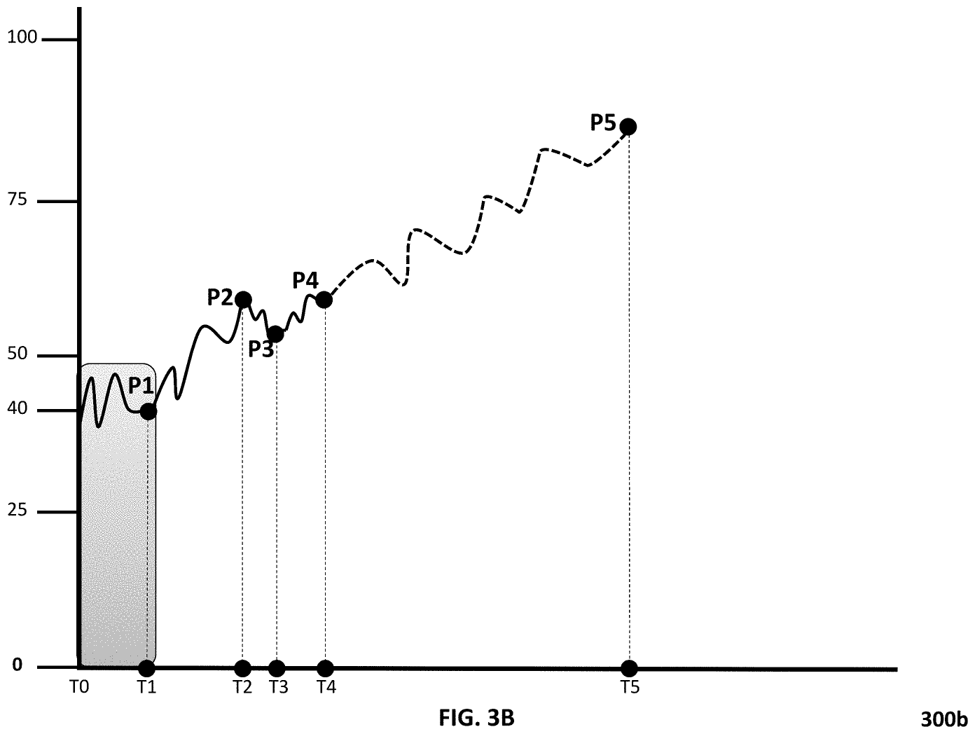

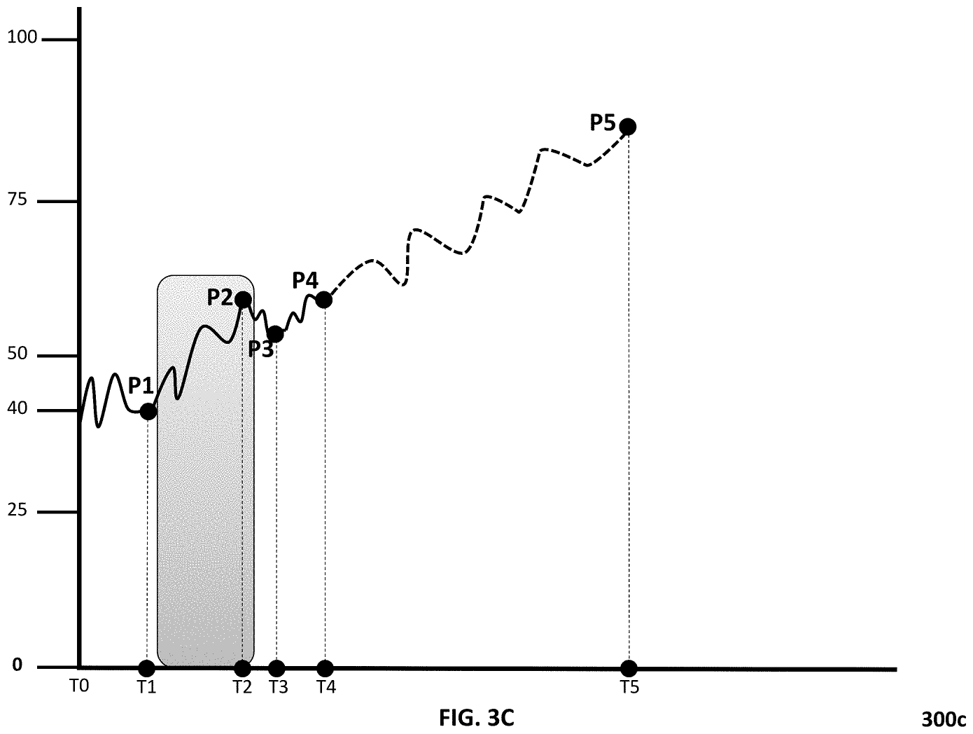

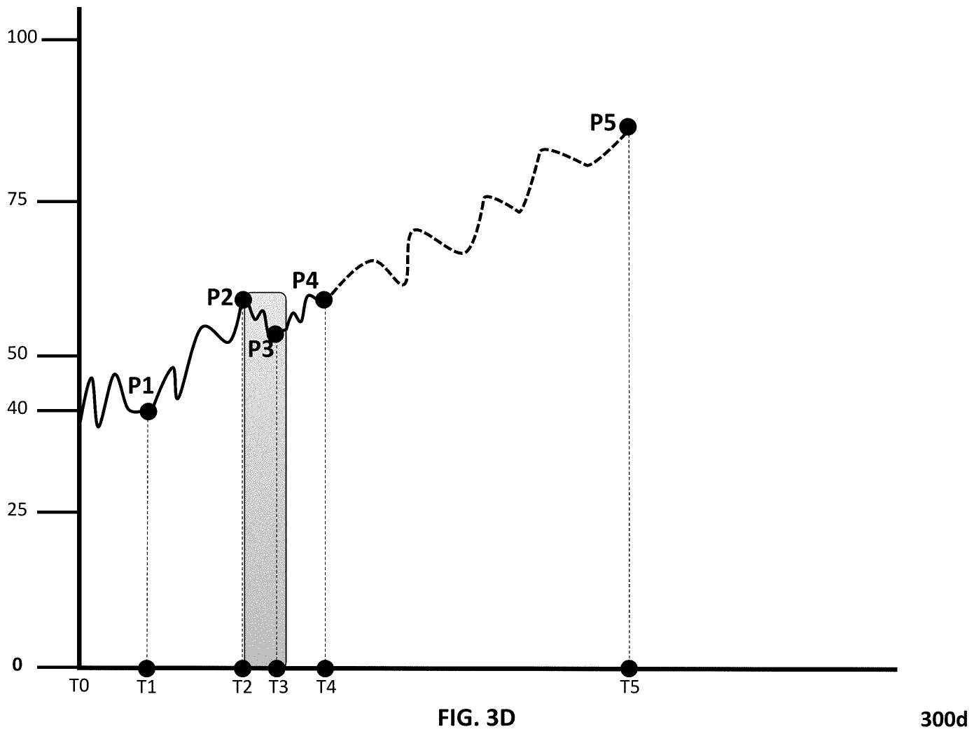

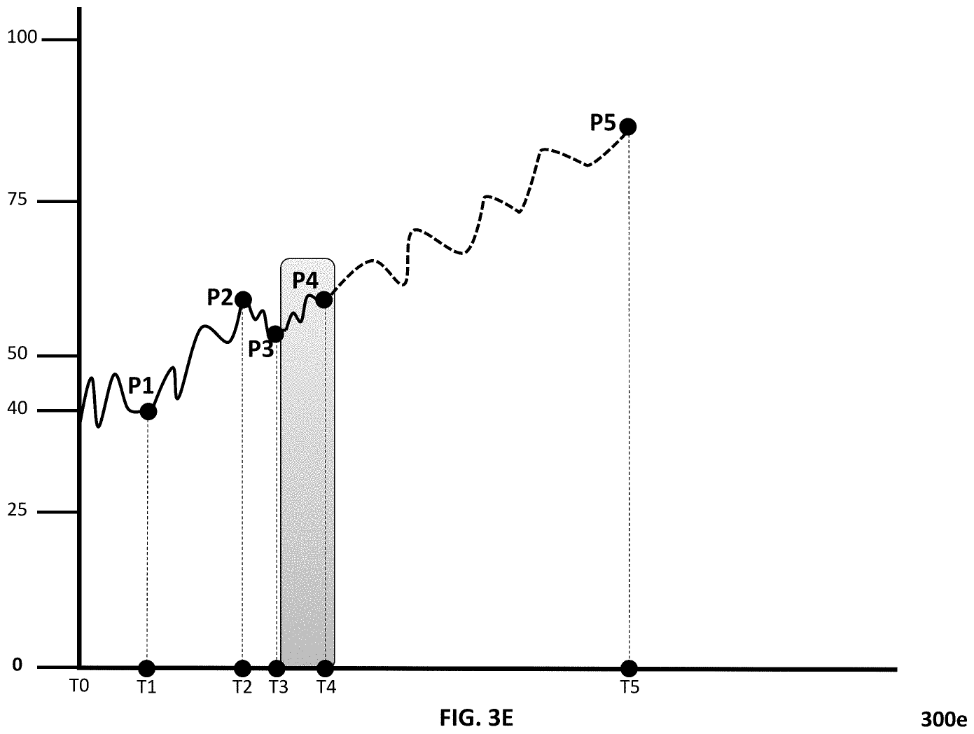

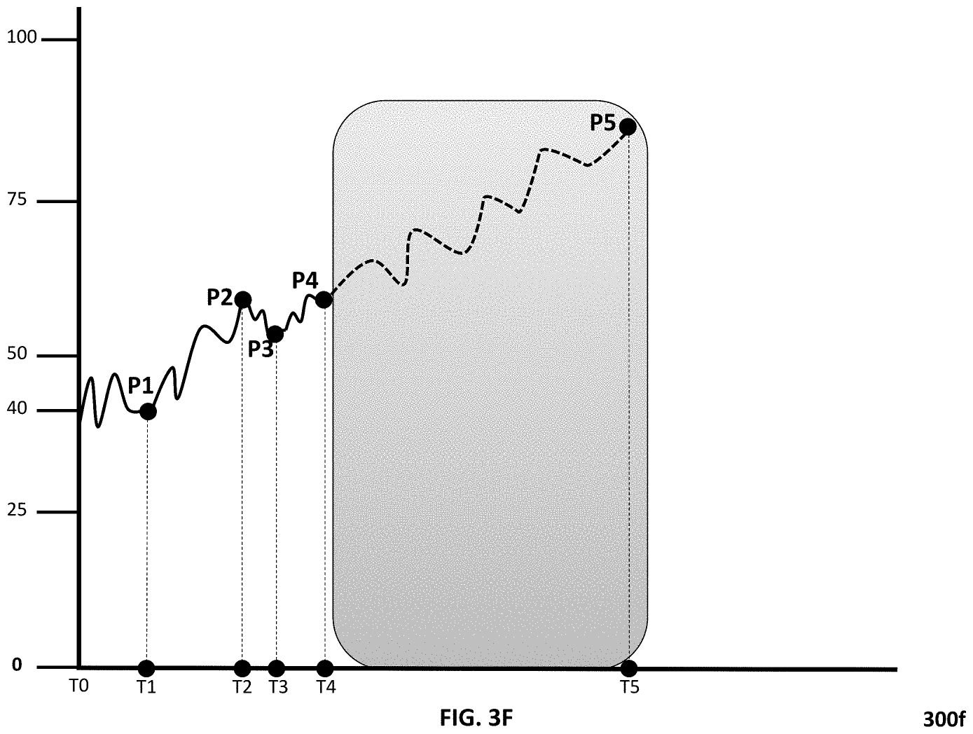

Turning to FIG. 3A, graph 300a illustrates one embodiment of a timeline measuring one aspect of communication effectiveness (“engagement”) over various periods of time. Time is measured along the X axis with points (T0, T1, T2, T3 and T4) designating different snapshots in time corresponding to different measures of overall engagement. While engagement is measured on a continuous basis in one embodiment, the periods between these different points in time serve to illustrate how any particular goal/KPI (in this scenario, engagement) is affected by the advice generated by Communications Server 101.

While graph 300a illustrates how the present invention generates advice optimizing engagement over time, it generates advice in other embodiments optimizing other goals or combinations thereof, including advice that is segmented across one or more dimensions. For example, such advice may optimize engagement with respect to a particular program (e.g., a wellness program) being launched by an enterprise, or even a specific campaign of that program, such as an effort to increase exercise by employees.

In other embodiments, the present invention optimizes engagement (and/or other goals) with respect to a particular author, or a specific department or other audience segment, or even discrete types of communications (e.g., surveys)—any of which may be further segmented over a particular period of time. For example, the present invention may generate advice optimizing engagement by members of an enterprise's marketing department with respect to surveys published during a 3-month period preceding launch of a new campaign.

The features of the present invention illustrated in graph 300a (and in subsequent FIGS. 3B-3F) are described below in the context of a particular scenario—an animation enterprise with various departments (animators, engineers, writers, sales and marketing, etc.) and a desire to improve engagement generally between its employees and the authors of communications (whether senior executives, department heads or “ordinary” employees). In this simple scenario, engagement is predefined as an average of three derived metrics (open rate, like rate and comment rate). As noted above, other more complex functions may be employed without departing from the spirit of the present invention.

Turning to FIG. 3B, graph 300b illustrates a “baseline” (shaded) section of graph 300a in FIG. 3A—i.e., the period from time T0 to time T1, with point P1 on the graph representing the enterprise-wide engagement level at time T1. During this time period, the present invention monitors and analyzes metrics and generates advice, but has not yet presented such advice to authors of communications. In this embodiment, a baseline engagement level facilitates future predictions designed to optimize engagement, as well as decisions as to when to present generated advice to authors.

Graph 300b illustrates the fact that, during this time period, the enterprise's engagement level experiences short-term fluctuations (frequent increases and decreases)—though not due to any advice generated by the present invention, because authors have not yet seen any such advice. These fluctuations in engagement represent a typical pattern that might be expected in any enterprise.

Apart from the lack of presenting advice to authors, the present invention monitors authors' publication of communications, including attribute values of the various communication attributes of such publications, such as the author, title, communication type, purpose, reading level, target audience and many others, as discussed above. For example, a particular author may publish multiple articles targeted at the writing staff designed to present a broad overview of (and elicit feedback regarding) a new animated movie project being considered. Other authors may publish enterprise-wide surveys seeking employees' ranking of multiple different animation projects being considered.

The present invention further monitors and processes various metrics relating to such communications, including whether particular employees in the targeted audiences opened such communications, liked them, provided feedback, searched for related topics, etc. As discussed with respect to FIG. 2 above, the present invention transforms these raw, derived and aggregated metrics into advice designed to optimize engagement over time.

Moreover, as discussed above, these metrics, which represent the behavioral interactions of targeted audiences with published content, are more than merely the result of access to such content. They are an integral component of the two-way dialogue between authors and viewers of content. It is this continuous dialogue that drives the iterative generation of advice designed to improve engagement (and/or other goals) over time.

Such advice (even though not yet presented to authors) may indicate, for example, that communications to the writing staff relating to prospective projects were most effective (i.e., generated higher levels of engagement) after 5 PM on Fridays—perhaps because the writers tended to read, think about and otherwise interact with them over the weekend, as opposed to when they were preoccupied with their day-to-day activities during the work week. Moreover, such advice may further indicate that “fact-driven” titles and a “neutral” tone were most effective regarding communications targeted at the engineering department.

In one embodiment, the duration of this baseline period is a predefined period of time, while in other embodiments the end of the baseline period is determined by a predefined condition. For example, once the fluctuations remain “consistent” (e.g., standard deviation within a predefined range) for a period of time, the system can be deemed to be exhibiting a stable baseline engagement level.

In any event, following this baseline period, the present invention begins to provide advice to authors in accordance with the process described in step 255 of flowchart 200 above. Remaining FIGS. 3C, 3D, 3E and 3F illustrate representative fluctuations in engagement resulting from authors incorporating in their communications the advice automatically generated by the present invention over time. As will become apparent from the descriptions below, the frequent fluctuations in engagement typically exhibit a long-term upward trend (assuming authors generally incorporate the advice provided by the present invention)—akin to the general rise in stock market prices over long periods of time, despite daily volatility. In this context, however, this upward trend in engagement levels is a product of the advice generated by the present invention.

However, as will be illustrated by the description of FIGS. 3D and 3E below, medium-term fluctuations in engagement levels may still occur. In particular, as the nature and membership of target audiences change over time, the present invention effectively adapts by generating advice that correlates to such changes.

Turning to FIG. 3C, the shaded section of graph 300c represents the time period from time T1 to time T2, with point P2 on the graph representing the enterprise-wide engagement level at time T2. This time period represents the result of authors incorporating the advice generated by the present invention, which predictably results in an increase in the enterprise-wide engagement level. For example, as noted above, articles relating to a potential new animated movie project under consideration may now be targeted at the writing staff and published after 5 PM on Fridays. As a result, increased rates of feedback and other engagement-related metrics are experienced, leading to this rise in the overall engagement level (and, in other embodiments, in a rise in a segmented engagement level limited to the writing staff).

Similarly, such increases are experienced in other areas of the enterprise as advice relating to various different attributes (and combinations of attributes) is incorporated into different types of communications. For example, such advice may reveal that different types of surveys are most effective when targeted at particular audience segments. Engineers may be more likely to respond to more objective surveys, while the marketing department may be more likely to respond to more open-ended philosophical survey questions.

While the permutations of advice regarding communication attributes are virtually limitless, the present invention automatically predicts the extent to which values of particular communication attributes will impact (alone or in combination) the enterprise's predefined goals, such as engagement. In other embodiments, various parameters may be modified dynamically. For example, an enterprise may add, revise or eliminate the monitoring of certain predefined metrics, or may do the same with respect to particular communication attributes or the functions that represent predefined goals (or even establish new such goals).

While the incorporation of advice generated by the present invention typically results in an increase in engagement and other predefined goals, such improvements cannot be guaranteed. For example, membership in a particular target audience (e.g., the engineering department) may change over time as certain employees depart and others join the department. The advice that was effective for the engineering department in the past may be ineffective due to such changes in personnel—at least until the system “adapts.”

Turning to FIG. 3D, the shaded section of graph 300d represents the time period from time T2 to time T3, with point P3 on the graph representing the enterprise-wide engagement level at time T3. This time period represents a decrease in the level of engagement despite the incorporation of automatically generated advice. In this scenario, for example, some of the more “active” users in the engineering department have left the company. As a result, the level of engagement in the engineering department (and thus the enterprise as a whole) decreases. The missing contribution of those departing users, who frequently viewed communications, provided feedback and otherwise interacted with the system, had a significant impact on the overall level of engagement.

In other scenarios, this impact may be attributed to departing personnel across multiple departments (including those who were reassigned, relocated or transferred across groups), or even to changes in the behavior of existing personnel. For example, as people become busy on particular projects, their degree of interaction with communications generally may wane. Moreover, this impact may result from the addition of personnel (whether or not they are replacing departing users) who interact with the system less actively than others.

Regardless of the reason for this negative impact on the level of engagement, it is important to note that the nature and membership of target audiences do not necessarily remain static. Over time, the present invention adapts to these dynamic changes in target audiences by providing “adaptive” advice that is predicted to yield metrics that optimize the level of engagement. In other words, as metrics change (e.g., due to changes in the behavioral interactions of target audiences with communications), the resulting advice generated by the present invention changes accordingly (as described above with reference to FIG. 2).

For example, consider the scenario noted above in which the composition of the engineering department changes due to departing employees. While the departing members were willing to read and interact with longer and more philosophical articles, the remaining members are not responsive to such communications. They are more inclined to interact with communications having different communication attributes, such as shorter, more objective and fact-driven communications. As a result, the advice automatically generated by the present invention effectively “adapts” to these changes in the target audience.

Authors of communications intended for the engineering department incorporate such advice into their communications, preparing shorter articles and simpler surveys that are targeted at more specific objective criteria. Viewers of such communications in turn respond more favorably by interacting more frequently and providing more and better feedback. Over time, this process results in a turnaround in the level of engagement.

Turning to FIG. 3E, the shaded section of graph 300e represents the time period from time T3 to time T4, with point P4 on the graph representing the enterprise-wide engagement level at time T4. This time period represents an increase in the level of engagement as a result of the incorporation of automatically generated “adaptive” advice, as noted above.

As the remaining members of the engineering department interact with communications targeted at their “altered” behavior, the resulting metrics generate an increase in the level of engagement with respect to the engineering department and the enterprise as a whole. As noted above, these effects need not be isolated to an individual department. In other scenarios, these changes in targeted audiences ripple across multiple departments throughout the enterprise.

Moreover, these effects reflect differences in the behavioral interaction of target audiences with various different communication attributes—from the time of publication to the length of communications and their titles to reading levels, styles and types of communications, as well as many other attributes. It should also be noted that, as authors generate communications addressing new subject matter (such as an upcoming animated movie), target audiences may respond in different (sometimes unexpected) ways. This in turn may lead to short-term increases and decreases in the level of engagement while the present invention adapts to such changes. But, as noted above, the general trend with respect to engagement and other defined goals will typically be an upward one.

Finally, turning to FIG. 3F, the shaded section of graph 300f represents the time period from time T4 to time T5 with point P5 on the graph representing the enterprise-wide engagement level at time T5. This time period represents a significant long-term adaptive increase in the level of engagement (despite short-term and medium-term increases and decreases reflecting changes in targeted audiences over shorter periods of time) as a consequence of the present invention continuously adapting to such changes over time.

The nature of the long-term time period illustrated in graph 300e is (as noted above) akin to the general rise in stock market prices over long periods of time, despite daily volatility. In this context, the general rise in engagement and other enterprise goals (alone and in combination) results from the fact that the present invention learns to correlate, on a continuous basis, the dynamic two-way relationships between the attribute values of authors' communications and the metrics representing the behavioral interactions of target audiences with such communications. It employs such correlations to automatically generate advice designed to yield metrics that optimize an enterprise's predefined goals over time, while adapting such advice to dynamic changes in the nature and membership of target audiences (which cause short-term fluctuations in such goals).

In one embodiment, enterprises periodically revise the communication attributes and/or goals employed by the present invention. For example, if a rise in engagement over time is not deemed sufficient, the enterprise may employ analytics (from the data generated by the present invention) to identify other communication attributes that are missing or not adequately characterized. Similarly, such analytics may give rise to a new or revised goal which the present invention can optimize in the future.

In other embodiments, as noted above, an enterprise's goals are segmented across one or more different dimensions, including time, target audiences, communication types, topics, authors and virtually any other relevant segment or combination thereof within a particular enterprise. By constraining the predictive capabilities of the present invention to one or more of these dimensions, the present invention facilitates the generation of more targeted advice to authors.

The present invention has been described with respect to specific embodiments discussed above and illustrated in the accompanying drawings. It will be apparent to those skilled in the art that numerous other embodiments may be implemented without departing from the spirit of the present invention. For example, the functionality of Communications Server 101 and client software 193 may be embodied in different combinations of hardware and software, and combined into a smaller number or divided into a larger number of different modules.

Moreover, various different metrics or combinations thereof may be monitored, and thus incorporated as parameters of different KPIs or goals of an enterprise or other entity. Such metrics and goals (functions thereof) may be static or modified dynamically during the course of a two-way dialogue between authors and viewers of communications. Different communication attributes may be correlated with the metrics (alone or in combination), having various different value ranges.

Variations of the machine learning techniques described herein (including statistical regression, supervised and unsupervised machine learning and other statistical, predictive, heuristic, optimizing, mathematical and analytic techniques) may also be employed without departing from the spirit of the present invention. Other embodiments may generate advice for authors to incorporate into their communications and may also generate a subset of such communications entirely without human intervention.

1. A feedback-driven enterprise communications platform that improves communication effectiveness between authors and viewers of communications, each communication having a quantified value corresponding to each of a plurality of attributes of the communication, the platform comprising:
(a) a metrics analyzer that generates metrics representing the interactions of a plurality of viewers with a plurality of communications over time;
(b) a goal optimizer that defines one or more goals as a measure of communication effectiveness, each goal represented as a function of the metrics; and
(c) an advice generator that generates advice for authors of future communications, wherein the advice represents values or ranges of values of the plurality of attributes designed to achieve the one or more defined goals.

2. The platform of claim 1, further comprising a prediction engine that correlates the metrics with the quantified values of the attributes of communications over time and employs such correlations to predict future metrics from attribute values or ranges of values provided to the advice generator.

3. The platform of claim 1, wherein the advice generator generates advice representing attribute values or ranges of values generated by the goal optimizer to optimize the one or more goals.

4. The platform of claim 1, wherein the metrics include raw, derived and aggregated metrics.

5. The platform of claim 1, wherein at least one of the defined goals is segmented across one or more different dimensions.

6. A method of improving communication effectiveness between authors and viewers of communications, each communication having a quantified value corresponding to each of a plurality of attributes of the communication, the method comprising the following steps:
(a) generating metrics representing the interactions of a plurality of viewers with a plurality of communications over time;
(b) defining one or more goals as a measure of communication effectiveness, each goal represented as a function of the metrics; and
(c) generating advice for authors of future communications, wherein the advice represents values or ranges of values of the plurality of attributes designed to achieve the one or more defined goals.

7. The method of claim 6, further comprising the steps of correlating the metrics with the quantified values of the attributes of communications over time, employing such correlations to predict future metrics from attribute values or ranges of values and generating advice representing such attribute values or ranges of values.

8. The method of claim 6, wherein the advice represents attribute values or ranges of values that optimize the one or more defined goals.

9. The method of claim 6, wherein the metrics include raw, derived and aggregated metrics.

10. The method of claim 6, wherein at least one of the defined goals is segmented across one or more different dimensions.
